(19) United States
(12) Patent Application Publication
(10) Pub. No.: US 2006/0131855 A1
(43) Pub. Date: Jun. 22, 2006

(54) Gas bag module with a discharge opening

(75) Inventor: Martin Kreuzer, Kleinwallstadt (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/301,563

(22) Filed: Dec. 13, 2005

(30) Foreign Application Priority Data
Dec. 16, 2004 (DE) 20 2004 019 448.1

(51) Int. Cl. B60R 21/26

(52) U.S. Cl. 280/740; 280/742

(57) ABSTRACT

A gas bag module for a vehicle occupant restraint device includes a rigid component (10). The rigid component (10) has a discharge opening (12) formed therein through which gas can escape. A plate (14) is arranged over the discharge opening (12) and overlaps the discharge opening (12) at a distance. The plate (14) is mounted elastically on the rigid component (10).

### TECHNICAL FIELD

The invention relates to a gas bag module for a vehicle occupant restraint device, in particular to a gas bag module with a discharge opening.

### BACKGROUND OF THE INVENTION

Basically, in a gas bag module, the gas bag is to be filled as quickly as possible with the gas generated by the gas generator. In particular cases it is, of course, desirable, to adapt the quantity of gas or the internal pressure in the gas bag to particular conditions. For this purpose, discharge openings which are able to be freed can be provided in the gas bag itself or in rigid components of the gas bag module.

From US 2004/0 051 285 A1 a gas bag module with valve flaps is known, which can close or free discharge openings formed in a gas generator carrier. The valve flaps are connected by limiting straps to a part of the gas bag fabric facing the vehicle occupant. On activation of the gas bag module, the valve flaps are initially in the open position, so that gas can escape. If the unfolding gas bag comes into contact very early with the vehicle occupant, the discharge openings remain open. Thereby, the pressure of the unfolding gas bag and hence the force exerted onto the vehicle occupant is reduced. If, on the other hand, the vehicle occupant is in a position which is further away from the gas bag module, the discharge openings are closed in the course of the further unfolding by the limiting straps, against the internal pressure of the gas bag, so that no more gas can flow off. US 2004/0 051 285 A1 also mentions another design, according to which the valve flaps are initially closed and only open with increasing internal pressure of the gas bag.

It is an object of the invention to provide a gas bag module with a discharge opening, the effective cross-section of which regulates itself by simple means.

### BRIEF SUMMARY OF THE INVENTION

The gas bag module for a vehicle occupant restraint device according to the invention includes a rigid component. The rigid component has a discharge opening formed therein through which gas can escape. A plate is arranged over the discharge opening and overlaps the discharge opening at a distance. The plate is mounted elastically on the rigid component.

The construction according to the invention makes possible an automatic adaptation of the outflowing quantity of gas as a function of the pressure prevailing in the interior of the gas bag. The higher the internal pressure of the gas bag, the greater the forces which act on the plate arranged over the discharge opening. Owing to the elastic mounting, the plate is pressed more strongly against the discharge opening, so that the effective discharge cross-section is reduced and less gas can escape.

An embodiment which is able to be converted at a favourable cost makes provision that the plate rests on several elastic elements arranged around the discharge opening.

### BRIEF DESCRIPTION OF THE DRAWINGS

FIG. 1 shows a lateral sectional view of a part of a gas bag module with a discharge opening according to the invention; and

FIG. 2 shows a top view onto the cut-out of the gas bag module of FIG. 1.

### DETAILED DESCRIPTION OF THE PREFERRED EMBODIMENT

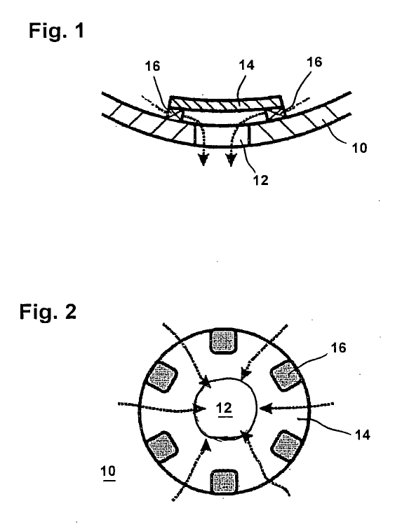

In FIG. 1 a rigid component 10 of a gas bag module is illustrated, which may be for example a gas generator carrier or a wall of a module housing. In the component 10 a discharge opening 12 is formed, through which a portion of the gas provided for the filling of the gas bag of the module can escape. On the inner side of the component 10, a plate 14 overlaps the discharge opening 12 at a particular distance. The distance is given by several elastic elements 16 on which the plate 14 is mounted.

In FIG. 2 the plate 14 is illustrated so as to be transparent, in order to make visible the arrangement of the elastic elements 16. The elastic elements 16 are placed spaced apart from each other in peripheral direction around the discharge opening 12, so that between the elements 16, delimited by the rigid component 10 and the plate 14, several flow channels to the discharge opening 12 are formed. The height of the flow channels is determined by the distance of the plate 14 from the rigid component 10.

With a filling of the gas bag of the module, the elastic elements 16 are pressed together in the case of an intensively rising gas bag internal pressure, owing to the forces acting on the plate 14. Thereby, the height of the flow channels is reduced and hence the effective cross-section of the discharge opening 12, i.e. the quantity of the outflowing gas is limited as a function of the internal pressure of the gas bag.

1. A gas bag module for a vehicle occupant restraint device, the gas bag module including a rigid component having a discharge opening formed therein through which gas can escape, a plate being arranged over the discharge opening and overlapping the discharge opening at a distance, the plate being mounted elastically on the rigid component.

2. The gas bag module according to claim 1, wherein the plate rests on several elastic elements arranged around the discharge opening.
